(19) United States
(12) Patent Application Publication
(10) Pub. No.: US 2012/0039154 A1
(43) Pub. Date: Feb. 16, 2012

(54) TIMEPIECE WITH DISPLAY BY AN ENDLESS RIBBON

(76) Inventor: Francis Gerber, Bernex (CH)

(21) Appl. No.: 13/263,217

(22) PCT Filed: Apr. 1, 2010
(86) PCT No.: PCT/EP2010/054430

§ 371 Date: Oct. 6, 2011

(30) Foreign Application Priority Data
Apr. 7, 2009 (CH) 00566/09

(51) Int. Cl. G04B 19/20; G04B 3/00

(52) U.S. Cl. 368/216; 368/223

(57) ABSTRACT

A timepiece (1) with an endless ribbon (2) that shows time indications and travels around two parallel rollers (3, 4), and a rotary drive mechanism for at least one of these rollers, this roller being called the drive roller. The ribbon (2) is made up of strips (6) consisting of plates articulated together and extending parallel to the rollers (3, 4). At least the drive roller includes drive elements (17) for driving the strips (6).

### TECHNICAL FIELD

The present invention relates to a timepiece in which the display of time information is done using an endless ribbon rotating around the movement inside the case, the indications borne by said ribbon appearing through the glass.

### BACKGROUND OF THE INVENTION

A timepiece of this type is described, for example, in application WO 2007/110446 by the same applicant. This timepiece includes a flexible endless ribbon bearing time indications and stretched between two parallel rollers rotated by a drive mechanism. The flexible ribbon can be made from silk, metal, plastic, paper, or any other material. In order to drive the ribbon, the rollers can have, at their ends, toothings engaged with openings formed along the edges of the ribbon, like those of a photographic film. In order to allow the ribbon to slide to set it to time, the toothings of the rollers must be frictionally mounted thereon. This device can be complex and costly to produce.

Furthermore, the ribbon is made up of a fine flexible sheet, producing a display with the appearance traditionally encountered in ribbon watches, and known for example from patent CH 338 150. Due to the flexibility of the ribbon, the information displayed on the ribbon undergoes a deformation, in particular when the ribbon passes around the rollers. Because the materials used to print the ribbon do not withstand the deformation of the support, the display then tends to deteriorate over time.

Also known from U.S. Pat. No. 3,024,590 is a timepiece comprising an endless ribbon bearing time indications and traveling around two parallel rollers. The ribbon used can be a continuous elastic band, a metal spring bearing separate numbered plates or a spring whereof the coils are close enough together to be able to inscribe figures there. The spring or the elastic band have the drawback of deforming easily.

One aim of the present invention is therefore to offset these drawbacks, by proposing a timepiece with display by a ribbon, in which the ribbon constitutes a rigid enough support so that the display inscribed in the ribbon does not deform, in particular during passage of the ribbon around the rollers. The display can then be done from the range of materials usually used to make dials, for example.

Another aim of the present invention is to propose a timepiece with display by a ribbon allowing an original display of time information.

### BRIEF DESCRIPTION OF THE INVENTION

To that end, a timepiece is proposed including an endless ribbon bearing time indications and traveling around two parallel rollers, and a rotary driving mechanism for at least one of these rollers, said roller being called drive roller. According to the invention, said ribbon is formed by strips made up of plates articulated together and extending parallel to the rollers, at least said drive roller comprising means for driving said strips.

Thus, the strips, driven by the drive roller, travel when the drive roller is itself rotated by its drive mechanism. Each strip forms a support for the time indications rigid enough to receive any type of materials usually used for dials, these materials then not undergoing any deformation upon passage of the ribbon around the rollers.

Particularly advantageously, the plate of each strip can comprise two transverse side faces, each side face of a strip being arranged to be able to be assembled to the side face of an adjacent strip using a pivot, said pivot being arranged to cooperate with said means for driving said strips.

More particularly, each side face can comprise an orifice at one end and be extended at its other end by a fastening pad comprising a second orifice, said first and second orifices being arranged to receive a pivot so as to allow one strip to be assembled to an adjacent strip by inserting said pivot into the first orifice of the side faces of a strip and the second orifice of the fastening pads of the adjacent strip.

Preferably, the pivot can comprise a stem protruding from the side face of the strips, and the means for driving the strips provided on the drive roller can comprise at least one drive wheel secured to the drive roller and having a toothing meshing with the stems of the pivots of the strips traveling around the drive roller.

Advantageously, the rotary drive mechanism for at least one of the rollers comprises a barrel potentially coupled to an escapement and a regulator organ.

To allow the barrel to be wound, the roller can be passed through by an arbor secured by one end to the barrel and ending, at its other end, with a ratchet kinematically connected with a central winding pinion that can be actuated by a control stem. To allow the ribbon to be set, the control stem can be arranged to be kinematically connected with the means for driving the strips.

Advantageously, the time indications borne by the ribbon correspond to hours.

According to the alternatives, the ribbon can be made up of 12 or 24 strips, the means for driving the strips and the rotary driving mechanism for at least the drive roller being configured so that the ribbon performs, in the counterclockwise direction, one or more complete rotations in 12 or 24 hours.

The timepiece can also comprise means for displaying the minutes.

### BRIEF DESCRIPTION OF THE DRAWINGS

Other features of the invention will for example emerge from the description that follows, done in light of the appended drawings, in which:

FIG. 1 is a top perspective view of a timepiece according to the invention;

FIG. 2 is a side perspective view of the timepiece of FIG. 1, the ribbon being shown transparently;

FIG. 3 is a perspective view of one side of the timepiece, the ribbon having been partially removed;

FIG. 4 is a top view of FIG. 3, the upper face of the ribbon having been removed;

FIG. 5 is a partial perspective view of the timepiece showing the details of the driving mechanisms of the rollers and setting mechanisms, and

FIG. 6 is a partial bottom view of the strips used in the invention.

### DETAILED DESCRIPTION OF THE INVENTION

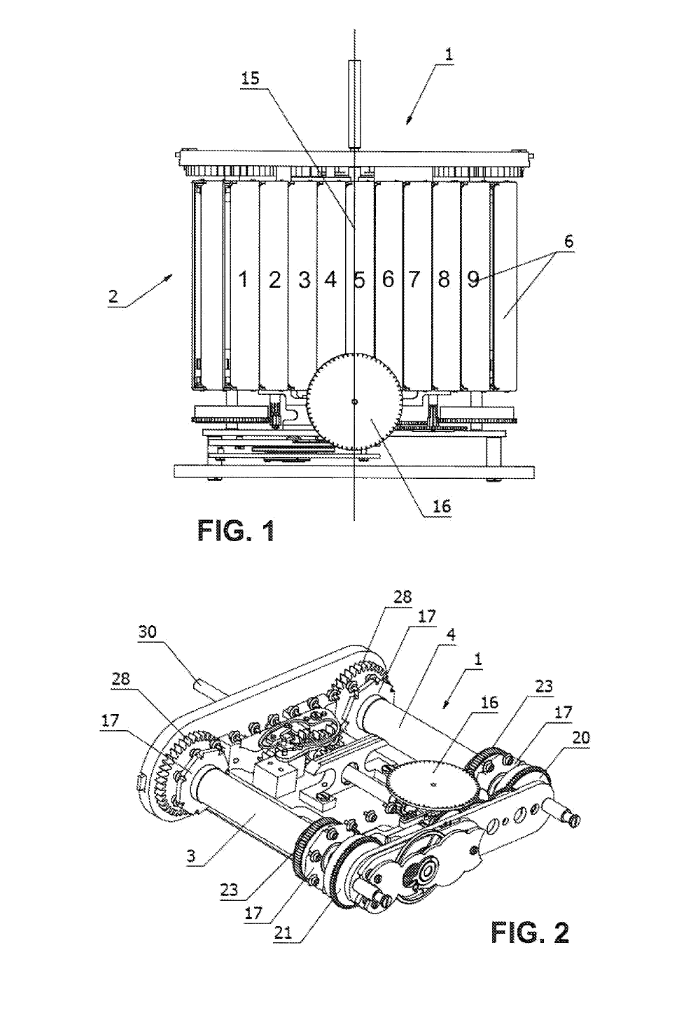

FIGS. 1 and 2 show a timepiece 1 including an endless ribbon 2 traveling around two parallel identical rollers 3 and 4 simultaneously rotated by a mechanism that will be described in detail later.

According to the invention, the ribbon 2 is formed by strips 6 articulated together, and extending parallel to the rollers 3 and 4.

In reference more particularly to FIG. 6, each strip 6 is formed by a plate 7, planar and with a rectangular section, comprising two side faces 8, extending transversely and substantially perpendicular to said plate 7, toward the inside of the timepiece 1. In FIG. 6, only one side face 8 is shown, the other face being made symmetrically.

Each side face 8 comprises a first orifice at one end 8a and is extended at its other end 8b by a fastening pad 9 comprising a second orifice. Said first and second orifices are arranged to receive a pivot 10 so as to allow a strip 6 to be assembled to an adjacent strip 6a or 6b by inserting said pivot 10 into the first orifice of the side faces 8 of a strip 6 or 6a and the second orifice of the fastening pads 9 of the adjacent strip 6b or 6, respectively.

The strips are assembled to each other so as to form the endless ribbon 2 and are articulated together using pivots 10, a stone 12 being associated with each pivot 10.

The strips are for example made from a metal material or any other suitable material. For information, a strip can have a length of about 21 mm for a width of about 3 mm.

The strips 6 have indications corresponding to the hours. In the illustrated alternative, the ribbon 2 includes 24 strips, each strip 6 bearing the indication of an hour, and the rollers 3 and 4 move the ribbon 2 counterclockwise, at a rate of one complete rotation per day. In another alternative that is not illustrated, the ribbon can comprise 12 or 36 strips and the rollers move the ribbon at a rate of one or more complete rotations per day. The ribbon can also include 24 strips, the indication of an hour being borne by a pair of strips. In that case, the ribbon performs two complete rotations per day.

A fixed line 15 arranged above the ribbon 2 serves as a reference for reading the hours, the hour being that indicated by the figure inscribed on the strip located under the line 15. Said line can for example be inscribed on the glass of the timepiece. The line can also be replaced by a hand or any other index fixed under the glass, to the movement itself or in any way that is suitable for one skilled in the art.

The minutes are displayed using a disk 16 or any other suitable display known by those skilled in the art. Advantageously, the disk 16 is arranged under the line 15 so that the line 15 also indicates the minutes, for example by the passage at the high point of the corresponding figure on the disk 16 under the line 15. The mechanism for driving the disk 16 will be described later.

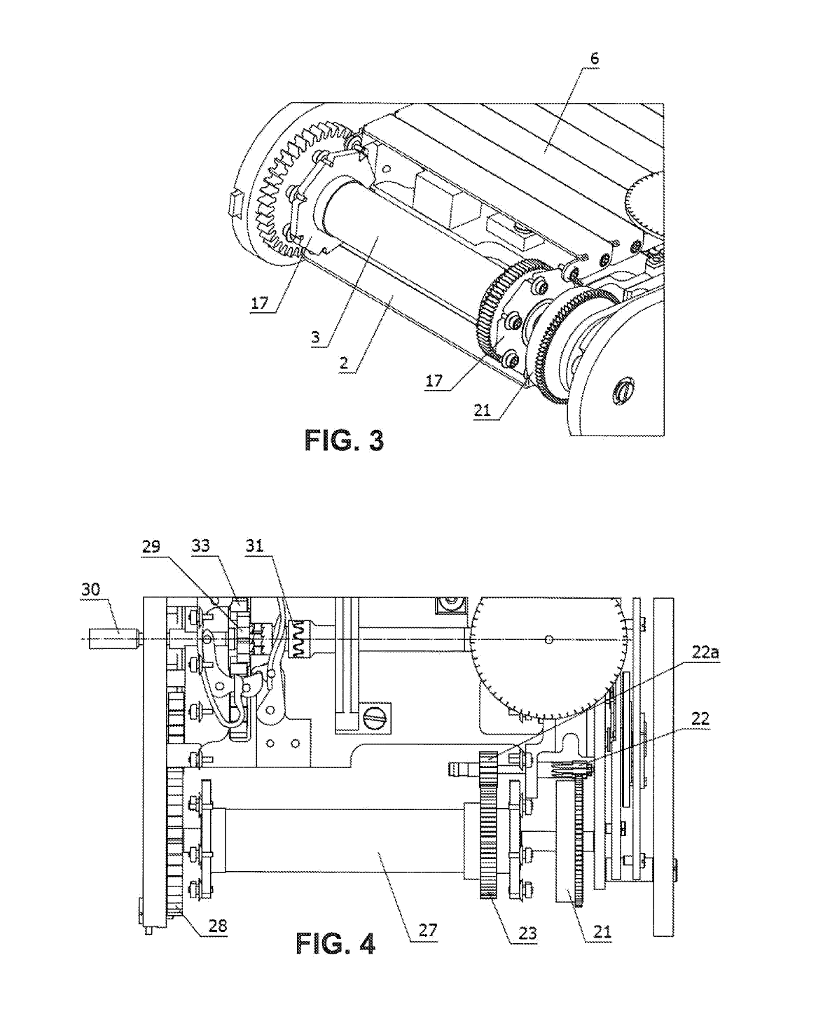

According to the invention, the rollers 3 and 4 comprise, to move the ribbon 2, means for driving the strips 6. In reference to FIGS. 2 and 3, said means for driving the strips 6 comprise a drive wheel 17 securely fixed approximately to each end of the rollers 3 and 4. Moreover, each pivot 10 comprises a stem 18 long enough for it to protrude from the side face 8 of the strips 6 toward the inside. The drive wheels 17 include a toothing having a shape adapted to be able to mesh with the stems 18 of the pivots 10 of the strips 6 when they travel around the rollers 3 and 4. The dimensions of the pieces are therefore chosen so that the position of the drive wheels 17 coincides when the position of the pivots 10 so that the pivots 10 meshing with the toothing of the drive wheels 17 are driven and in turn drive the strips 6 when the drive wheels 17 rotate.

To rotate the drive wheels 17, each roller 3, 4 is pivotably mounted on the frame of the movement, and is provided with a rotary drive mechanism that comprises a barrel 20, 21, respectively. Each barrel 20, 21 cooperates with the rollers 4 and 3, respectively, via a reduction train 22, which comprises a pinion 22a meshing with a toothed wheel 23 secured to the roller 3, 4 carrying the drive wheels 17.

Thus, the relaxation, over time, of the springs contained in the barrels 20, 21 ensures their rotation, and thus the rotation of the reduction trains 22, which in turn rotate the toothed wheels 23. The latter, secured to the rollers 3 and 4, rotate said rollers, which causes the drive wheels 17 to rotate. The latter cooperate with the stems 18 of the pivots 10 to make the strips 6 move, as described above.

In the illustrated alternative, the two rollers 3 and 4 are rotated, but of course only one of the rollers can be rotated, said roller then being called drive roller.

In the illustrated alternative, the barrel 20 is regulated by a traditional escapement/regulator organ system of the mechanical timepieces.

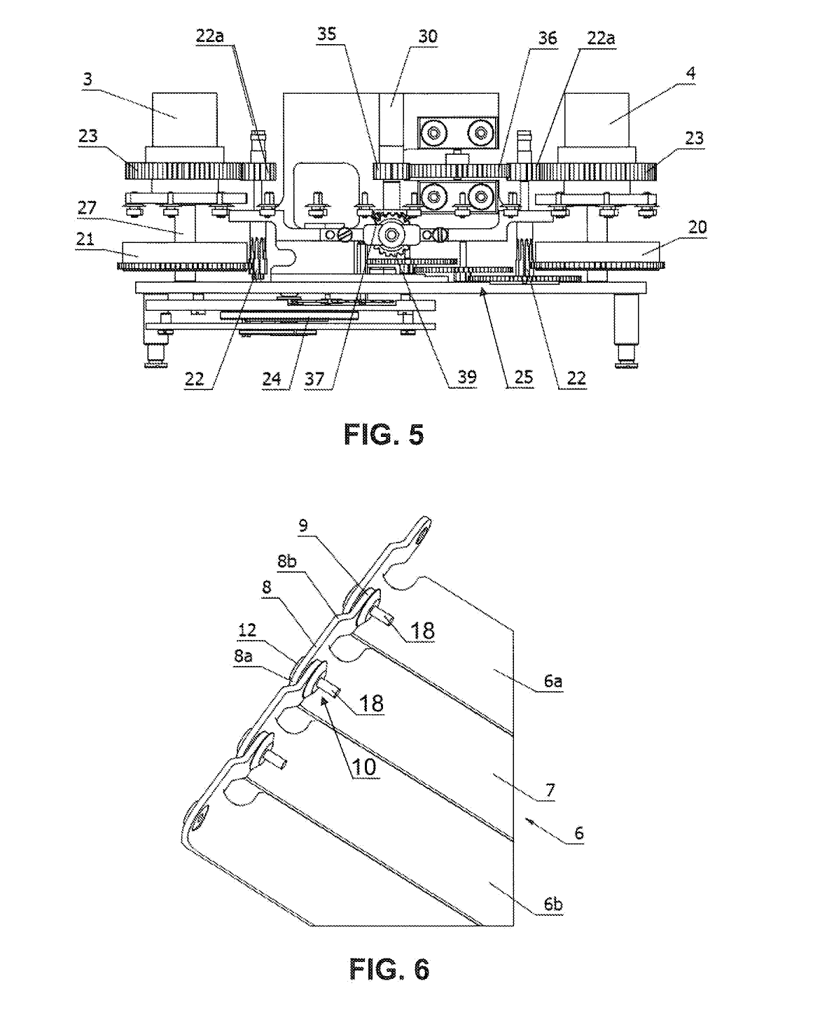

To that end, and relative to FIG. 5, the barrel 20 is coupled, traditionally, to an escapement wheel and a balance 24 via a going train 25. Such a going train is known by those skilled in the art and will not be described in more detail. Advantageously, the reduction train 22 of the barrel 20 is mounted on an axis of one of the elements of the going train.

The barrel 21 is not regulated by a specific system and plays a pulling function. It pulls on the barrel 20 while turning on the ribbon 2 and improving the torque of the system. In another alternative that is not shown, the regulator organ can be arranged so as to be shared by the two barrels 20, 21. It is obvious that when there is only a single drive roller, the escapement/regulator organ system is provided on said drive roller.

To allow each of the barrels 20, 21 to be wound, as an example, each roller 3, 4 is passed through by an arbor 27 secured by one of its ends to the core of the corresponding barrel 20, 21. Said arbor 27 acts as a winding axis. The arbor 27 rotates freely in the roller 3, 4, so that when it is rotated during winding, only the spring of the barrels is driven. At its other end, each arbor 27 ends with a ratchet 28 kinematically connected, via returns 33, with a central winding pinion 29 that can be actuated by a control stem 30, parallel to the axes of the rollers 3 and 4, and that can be rotated and translated traditionally. The control stem 30 also comprises a castle wheel 31. The winding pinion 29 and the castle wheel 31 operate traditionally, so that the winding mechanism is known by those skilled in the art and will not be described in further detail.

To allow setting, and as an example, the control stem 30 is arranged to be kinematically connected with the driving wheel 17 of the roller 4. The control stem 30 also serves as a driving arbor for the minutes. To that end, in reference to FIG. 5, the control stem 30 carries a first pinion 35 meshing with an intermediate wheel 36, which in turn meshes with the pinion 22a of the reduction train 22. The control stem also has a second pinion 37 at its end forming a field meshing with a wheel 39 secured to the disk 16 to display the minutes. Thus, when the barrel 20 rotates, the reduction train 22 and its pinion 22a drive the wheel 23 of the roller 4, on the one hand, to display the hours, and on the other hand the intermediate wheel 36, the pinions 35 and 37 and the wheel 39 to display the minutes.

One skilled in the art knows how to choose the dimensions and the number of teeth of the different elements so that the driving wheel 17 and the disk 16 rotate at speeds corresponding to their functions.

To be able to set the time, the pinions 22a of the reduction trains 22 are indented, and the rotation of the control stem 30 rotates the disk 16 and the driving wheel 17 to adjust the minutes and hours, respectively.

This description has been done in reference to an endless ribbon made up of strips articulated together, making it possible to display the hours. It goes without saying that many other indications can thus be provided by such a movement. In this way, the strips can be used to display time zones.

1-10. (canceled)

11. A timepiece including an endless ribbon bearing time indications and traveling around two parallel rollers, and a rotary driving mechanism for at least one of these rollers, said roller being called drive roller, wherein said ribbon is formed by strips articulated together using pivots, said strips being made up of plates extending parallel to the rollers, and wherein at least said drive roller comprises means for driving said strips, said pivots being arranged to cooperate with said means for driving said strips.

12. The timepiece according to claim 11, wherein the plate of each strip can comprise two transverse side faces, each side face of a strip being arranged to be able to be assembled to the side face of an adjacent strip using a pivot.

13. The timepiece according to claim 12, wherein each side face comprises a first orifice at one end and is extended at its other end by a fastening pad comprising a second orifice, said first and second orifices being arranged to receive a pivot so as to allow one strip to be assembled to an adjacent strip by inserting said pivot into the first orifice of the side faces of a strip and the second orifice of the fastening pads of the adjacent strip.

14. The timepiece according to claim 12, wherein the pivot comprise a stem protruding from the side face of the strips and wherein the means for driving the strips provided on the drive roller comprises at least one drive wheel secured to the drive roller and having a toothing meshing with the stems of the pivots of the strips traveling around the drive roller.

15. The timepiece according to claim 13, wherein the pivot comprise a stem protruding from the side face of the strips and wherein the means for driving the strips provided on the drive roller comprises at least one drive wheel secured to the drive roller and having a toothing meshing with the stems of the pivots of the strips traveling around the drive roller.

16. The timepiece according to claim 11, wherein the rotary drive mechanism for at least one of the rollers comprises a barrel potentially coupled to an escapement and a regulator organ.

17. The timepiece according to claim 16, wherein, to allow the barrel to be wound, the roller can be passed through by an arbor secured by one end to the barrel and ending, at its other end, with a ratchet kinematically connected with a central winding pinion that can be actuated by a control stem.

18. The timepiece according to claim 17, wherein, to allow the ribbon to be set, the control stem can be arranged to be kinematically connected with the means for driving the strips.

19. The timepiece according to claim 11, wherein the time indications borne by the ribbon correspond to hours.

20. The timepiece according to claim 19, wherein the ribbon is made up of 12 strips, the means for driving the strips and the rotary driving mechanism for at least the drive roller being configured so that the ribbon performs, in the counterclockwise direction, one or more complete rotations in 12 hours.

21. The timepiece according to claim 19, wherein the ribbon is made up of 24 strips, the means for driving the strips and the rotary driving mechanism for at least the drive roller being configured so that the ribbon performs, in the counterclockwise direction, one or more complete rotations in 24 hours.

22. The timepiece according to claim 12, wherein the time indications borne by the ribbon correspond to hours.

23. The timepiece according to claim 22, wherein the ribbon is made up of 12 strips, the means for driving the strips and the rotary driving mechanism for at least the drive roller being configured so that the ribbon performs, in the counterclockwise direction, one or more complete rotations in 12 hours.

24. The timepiece according to claim 22, wherein the ribbon is made up of 24 strips, the means for driving the strips and the rotary driving mechanism for at least the drive roller being configured so that the ribbon performs, in the counterclockwise direction, one or more complete rotations in 24 hours.

25. The timepiece according to claim 11, wherein it comprises means for displaying the minutes.

26. The timepiece according to claim 12, wherein it comprises means for displaying the minutes.
